(19) United States
(12) Patent Application Publication
(10) Pub. No.: US 2026/0142406 A1
(43) Pub. Date: May 21, 2026

(54) SHELL AND CONNECTOR

(71) Applicant: Yazaki Corporation, Tokyo (JP)

(72) Inventor: Hideto Kumakura, Makinohara-shi (JP)

(21) Appl. No.: 19/384,376

(22) Filed: Nov. 10, 2025

(30) Foreign Application Priority Data
Nov. 20, 2024 (JP) 2024-196687

(51) Int. Cl. H01R 13/512

(52) U.S. Cl. CPC H01R 13/512

(57) ABSTRACT

A shell according to one embodiment is a shell attached to a housing including a terminal accommodating portion that accommodates a terminal, a conductive member accommodating portion that is disposed adjacent to the terminal accommodating portion and accommodates a part of a conductive member extending from the terminal, and an opening that opens the terminal accommodating portion and the conductive member accommodating portion to an outside in a first intersecting direction intersecting an arrangement direction of the terminal accommodating portion and the conductive member accommodating portion, the shell including: a first shell that covers at least a first opening corresponding to the terminal accommodating portion in the opening; and a second shell that covers at least a second opening corresponding to the conductive member accommodating portion in the opening, in which the first shell and the second shell are rotatable relative to each other about an axis extending in the first intersecting direction.

### BACKGROUND OF THE INVENTION

### Field of the Invention

An embodiment of the present invention relates to a shell and a connector.

Priority is claimed on Japanese Patent Application No. 2024-196687 filed in Japan on Nov. 11, 2024, the content of which is incorporated herein by reference.

### Description of Related Art

A connector including a terminal, a housing that accommodates the terminal and a conductive member (a bus bar or an electric wire) extending from the terminal, and a shell that covers an opening of the housing is known. The opening of the housing is a portion of the housing that opens both an accommodating portion for the terminal (terminal accommodating portion) and an accommodating portion for the conductive member (conductive member accommodating portion) in the housing to the outside.

### PRIOR ART DOCUMENT

### Patent Document

Patent Document 1: Japanese Unexamined Patent Application, First Publication No. 2022-151014

### SUMMARY OF THE INVENTION

In such a type of connector, a direction of the conductive member extending from the terminal inside the housing (an extending direction of the conductive member) may change depending on an application. Due to such circumstances, a plurality of types of housings having different extending directions of the conductive member accommodating portion with respect to the terminal accommodating portion are prepared according to various applications of the connector. Hitherto, since a plurality of types of shells respectively corresponding to the plurality of types of housings are prepared, a manufacturing cost of the connector including the housing and the shell becomes high.

One embodiment provides a shell and a connector capable of reducing a manufacturing cost of the connector.

A shell according to one embodiment is a shell attached to a housing including a terminal accommodating portion that accommodates a terminal, a conductive member accommodating portion that is disposed adjacent to the terminal accommodating portion and accommodates a part of a conductive member extending from the terminal, and an opening that opens the terminal accommodating portion and the conductive member accommodating portion to an outside in a first intersecting direction intersecting an arrangement direction of the terminal accommodating portion and the conductive member accommodating portion, the shell including: a first shell that covers at least a first opening corresponding to the terminal accommodating portion in the opening; and a second shell that covers at least a second opening corresponding to the conductive member accommodating portion in the opening, in which the first shell and the second shell are rotatable relative to each other about an axis extending in the first intersecting direction, and the first shell and the second shell are disposed so as to be attachable to and detachable from each other in a state of being movable in the first intersecting direction and in a state of being immovable in a radial direction with respect to the axis.

A connector according to one embodiment includes the shell, the terminal, and the housing.

With the shell and the connector according to one embodiment of the present invention, the manufacturing cost of the connector can be reduced.

### BRIEF DESCRIPTION OF THE DRAWINGS

FIG. 1 is a perspective view of a routing unit including a connector according to one embodiment when viewed from a front side.

FIG. 2 is an exploded perspective view of a state in which a shell is detached from a housing in the connector according to one embodiment when viewed from the front side.

FIG. 3 is an exploded perspective view of a state in which the shell is detached from the housing in the connector according to one embodiment when viewed from a rear side.

FIG. 4 is an exploded perspective view of the shell illustrated in FIGS. 2 and 3 when viewed from the front side.

FIG. 5 is a front view of the shell illustrated in FIGS. 2 and 3 when viewed from the front side.

FIG. 6 is a front view of a state in which a second shell is rotated by a predetermined angle with respect to a first shell in the shell illustrated in FIG. 5 when viewed from the front side.

FIG. 7 is a front view of a state in which the housing is attached to the shell illustrated in FIG. 6 when viewed from the front side.

### DETAILED DESCRIPTION OF THE INVENTION

Hereinafter, embodiments will be described with reference to the drawings. In the following description, constitutions having the same or similar functions are denoted by the same reference numbers. Redundant descriptions of these constitutions may be omitted.

In the present disclosure, the terms are defined as follows. The term “connection” is not limited to a mechanical connection, and may include an electrical connection. Further, the term “connection” is not limited to a case where two elements that are connection targets are directly connected, and may include a case where two elements that are connection targets are connected with another element interposed therebetween. The term “to restrict” is not limited to a case where two members are in constant contact with each other, thereby restricting movement of one member with respect to the other member. The term “to restrict” may include, for example, a case where two members are not in contact with each other in a state in which no positional shift occurs, but the two members are brought into contact with each other when one of the two members is caused to be shifted with respect to the other, thereby restricting movement of one of the two members with respect to the other. In addition, “to restrict” means that movement in at least one direction is limited.

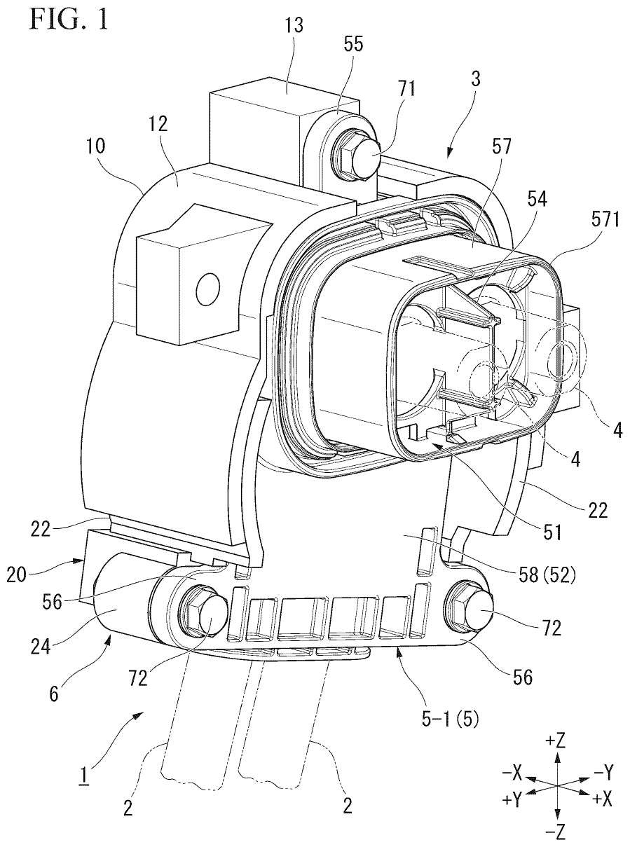

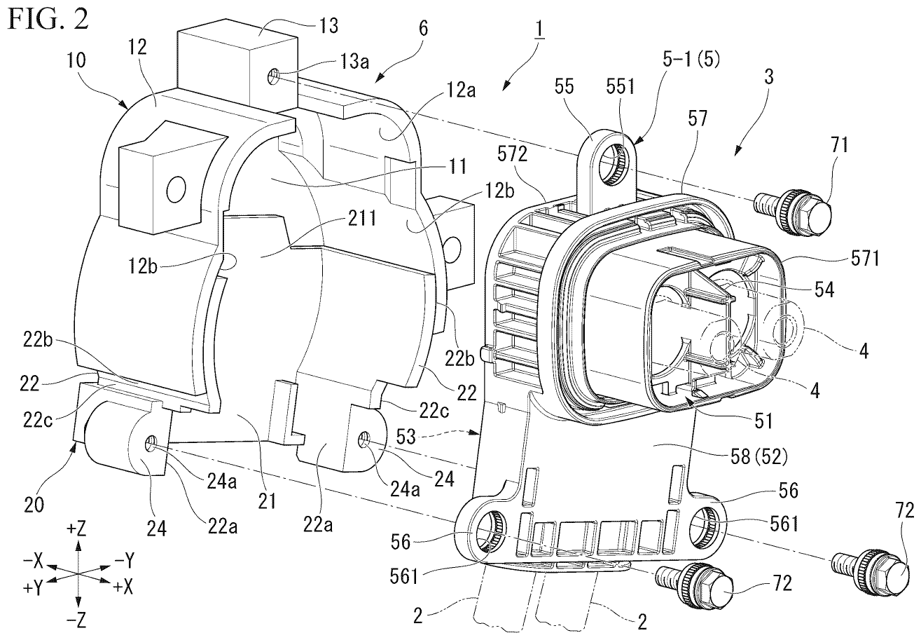

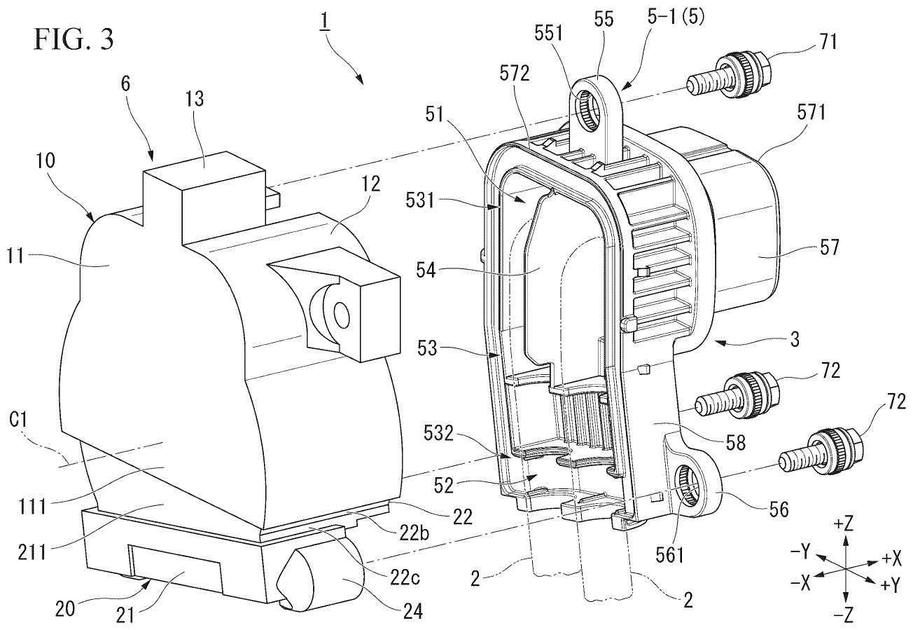

In the present disclosure, a +X direction, a −X direction, a +Y direction, a −Y direction, a +Z direction, and a −Z direction are defined as follows. The +X direction is a direction in which a shell 6 and a housing 5 of a connector 3 are arranged in order (see FIGS. 1 to 3). The −X direction is a direction opposite to the +X direction. When the +X direction and the −X direction are not distinguished from each other, they are simply referred to as “X direction”. The Y direction is a direction intersecting (for example, orthogonal to) the X direction. The +Y direction is a direction from one of two terminals 4 of the connector 3 to the other (See FIGS. 1 and 2). The −Y direction is a direction opposite to the +Y direction. When the +Y direction and the −Y direction are not distinguished from each other, they are simply referred to as “Y direction”. The +Z direction is a direction intersecting (for example, orthogonal to) the X direction and the Y direction. The +Z direction is a direction in which a conductive member accommodating portion 52 and a terminal accommodating portion 51 of the housing 5 are arranged in order (see FIG. 3). The −Z direction is a direction opposite to the +Z direction. When the +Z direction and the −Z direction are not distinguished from each other, they are simply referred to as “Z direction”. The Z direction is an example of an “arrangement direction of the terminal accommodating portion 51 and the conductive member accommodating portion 52”. The X direction is an example of a “first intersecting direction” intersecting the arrangement direction. In addition, hereinafter, for convenience of description, the +X-direction side may be referred to as a “front side”, and a −X-direction side may be referred to as a “rear side”.

### 1. Connector

As illustrated in FIGS. 1 to 3, the connector 3 of one embodiment is a component for electrically connecting an electric wire 2 to a mating connector (not illustrated). The connector 3 is, for example, a connector 3 used for a vehicle such as an electric vehicle (EV), a hybrid electric vehicle (HEV), or a plug-in hybrid electric vehicle (PHEV). The connector 3 is, for example, a high-voltage connector in which a current of 100 V or higher flows. The connector 3 of the present embodiment is a connector 3 corresponding to two electrodes. However, the connector 3 may be, for example, a connector 3 corresponding to one electrode or a connector 3 corresponding to three or more electrodes.

The connector 3 includes the terminal 4, the housing 5, the shell 6, a first fastening member 71, and a second fastening member 72. The connector 3 constitutes the routing unit 1 together with the electric wire 2 (conductive member) connected to the terminal 4 of the connector 3.

### 2. Terminal

The terminal 4 is accommodated in the terminal accommodating portion 51 of the housing 5 described below. In the connector 3 illustrated in FIGS. 1 to 3, two terminals 4 are arranged in the Y direction, in the terminal accommodating portion 51. The number of terminals 4 in the connector 3 is not limited to two, and may be any number. In addition, the arrangement of the plurality of terminals 4 in the terminal accommodating portion 51 may be arbitrary.

### 3. Housing

As illustrated in FIGS. 2 and 3, the housing 5 is made of a material having an electrical insulation property (for example, a synthetic resin material). The housing 5 includes the terminal accommodating portion 51, the conductive member accommodating portion 52, an opening 53, an insulating wall 54, a first attaching portion 55, and a second attaching portion 56.

### 4. Terminal Accommodating Portion

The terminal accommodating portion 51 is a space in the housing 5, the space accommodating the terminal 4 described above. The terminal accommodating portion 51 of the present embodiment is a space inside a tubular portion 57 extending in the X direction and having both ends opened. With such a configuration, the terminal accommodating portion 51 is opened to a first end 571 side of the tubular portion 57 positioned on the front side (+X direction side) and a second end 572 side of the tubular portion 57 positioned on the rear side (−X direction side).

A portion of the tubular portion 57 on the first end 571 side is a fitted portion to be fitted to the mating connector. The terminal 4 accommodated in the terminal accommodating portion 51 is exposed to the outside of the housing 5 through an opening of the tubular portion 57 on the first end 571 side. With such a configuration, the terminal 4 is connected to a terminal (not illustrated) of the mating connector in a state in which the portion of the tubular portion 57 on the first end 571 side is fitted to the mating connector.

An opening of the tubular portion 57 on the second end 572 side is a first opening 531 that opens the terminal accommodating portion 51 to the outside from the rear side (−X direction side).

5. Conductive Member Accommodating Portion

As illustrated in FIG. 3, the conductive member accommodating portion 52 (electric wire accommodating portion) is a space in the housing 5, the space accommodating a part of the electric wire 2 (conductive member) extending from the terminal 4 accommodated in the terminal accommodating portion 51. The conductive member accommodating portion 52 is disposed adjacent to the terminal accommodating portion 51 so as to be immovable. A proximal end portion of the electric wire 2, which is adjacent to the terminal 4, is accommodated in the conductive member accommodating portion 52, and a portion of the electric wire 2 that further extends from the proximal end portion is led out to the outside of the conductive member accommodating portion 52. In the following description, a direction in which the electric wire 2 extends in the conductive member accommodating portion 52 may be referred to as an “extending direction of the conductive member accommodating portion 52”.

The conductive member accommodating portion 52 of the present embodiment is a space inside a guide portion 58 that guides the electric wire 2 extending from the terminal 4 in a predetermined direction. The guide portion 58 is formed integrally with the tubular portion 57. That is, the tubular portion 57 and the guide portion 58 are fixed so as not to move relative to each other. The guide portion 58 is connected to a portion of the tubular portion 57 on the second end 572 side. With such a configuration, the conductive member accommodating portion 52 communicates with the terminal accommodating portion 51 on the second end 572 side of the tubular portion 57.

In the present embodiment, the guide portion 58 extends from the tubular portion 57 in a direction intersecting the X direction. The guide portion 58 guides the electric wire 2 in a direction in which the guide portion 58 extends from the tubular portion 57. The extending direction of the guide portion 58 corresponds to the extending direction of the conductive member accommodating portion 52. In the housing 5 illustrated in FIG. 3, the guide portion 58 including the conductive member accommodating portion 52 extends in an inclined direction inclined toward a +Y direction side as it goes toward the −Z direction with respect to the tubular portion 57 including the terminal accommodating portion 51. In the housing 5, for example, the guide portion 58 may extend obliquely toward a −Y direction side as it goes toward the −Z direction with respect to the tubular portion 57 when viewed from the X direction. The guide portion 58 may extend in the −Z direction from the tubular portion 57.

The guide portion 58 has a second opening 532 that opens the conductive member accommodating portion 52 to the outside of the housing 5 from the rear side (−X direction side).

The opening 53 of the housing 5 opens the terminal accommodating portion 51 and the conductive member accommodating portion 52 described above to the outside in the −X direction (first intersecting direction). The opening 53 includes the first opening 531 and the second opening 532 described above.

### 6. Insulating Wall

As illustrated in FIGS. 2 and 3, the insulating wall 54 is positioned between the adjacent terminals 4 in the terminal accommodating portion 51 to electrically insulate the adjacent terminals 4 from each other. Specifically, the insulating wall 54 is positioned between the terminals 4 adjacent to each other in the Y direction in the terminal accommodating portion 51. The insulating wall 54 is formed in a shape extending in the X direction and the Z direction with the Y direction as a thickness direction.

### 7. Attaching Portion

The first attaching portion 55 and the second attaching portion 56 are portions of the housing 5 for fixing the shell 6 to the housing 5.

In the present embodiment, the first attaching portion 55 has a first attachment hole 551 through which a shaft portion of the first fastening member 71 used for attaching the shell 6 passes. The first attaching portion 55 is positioned on the second end 572 side of the tubular portion 57 and protrudes from the tubular portion 57 in a direction intersecting the X direction (the +Z direction in the illustrated example). The first attachment hole 551 penetrates through the first attaching portion 55 in the X direction. In the present embodiment, the first attaching portion 55 is formed integrally with the tubular portion 57 constituting the terminal accommodating portion 51 and is positioned away from the guide portion 58 constituting the conductive member accommodating portion 52.

The second attaching portion 56 is formed at a position different from that of the first attaching portion 55. The second attaching portion 56 has a second attachment hole 561 used for attaching the shell 6. The second attaching portion 56 is positioned on a −Z direction side (second opening 532 side) of the guide portion 58. The second attaching portion 56 protrudes from the guide portion 58 in a direction intersecting the X direction (a direction intersecting the X direction and intersecting the extending direction of the conductive member accommodating portion 52 in the illustrated example). The second attachment hole 561 penetrates through the second attaching portion 56 in the X direction. In the present embodiment, the second attaching portion 56 is formed integrally with the guide portion 58 constituting the conductive member accommodating portion 52, and is positioned away from the tubular portion 57 constituting the terminal accommodating portion 51. The second attaching portion 56 is formed to be connected to the guide portion 58 at a position away from the first attaching portion 55.

### 8. Shell

As illustrated in FIG. 1, the shell 6 is attached to the housing 5 to cover the opening 53 (see FIG. 3) of the housing 5. As illustrated in FIGS. 1 to 3, the shell 6 includes a first shell 10 and a second shell 20. The first shell 10 and the second shell 20 are made of a material having an electrical insulation property (for example, a synthetic resin material).

The first shell 10 covers, among the opening 53 of the housing 5, at least the first opening 531 (see FIG. 3) corresponding to the terminal accommodating portion 51. The second shell 20 covers, among the opening 53 of the housing 5, at least the second opening 532 (see FIG. 3) corresponding to the conductive member accommodating portion 52. As illustrated in FIG. 3, the first shell 10 and the second shell 20 are rotatable relative to each other about an axis C1 extending in the X direction (first intersecting direction).

Hereinafter, the configuration of the shell 6 of the present embodiment will be further described.

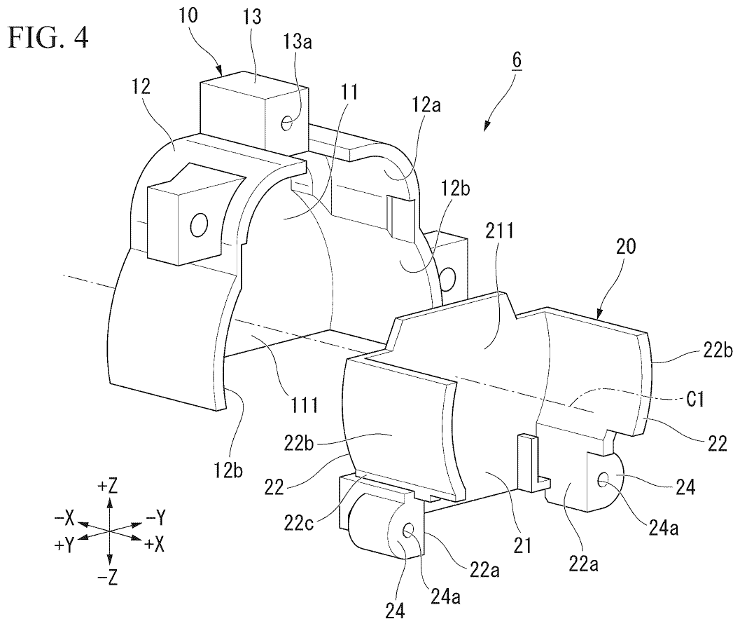

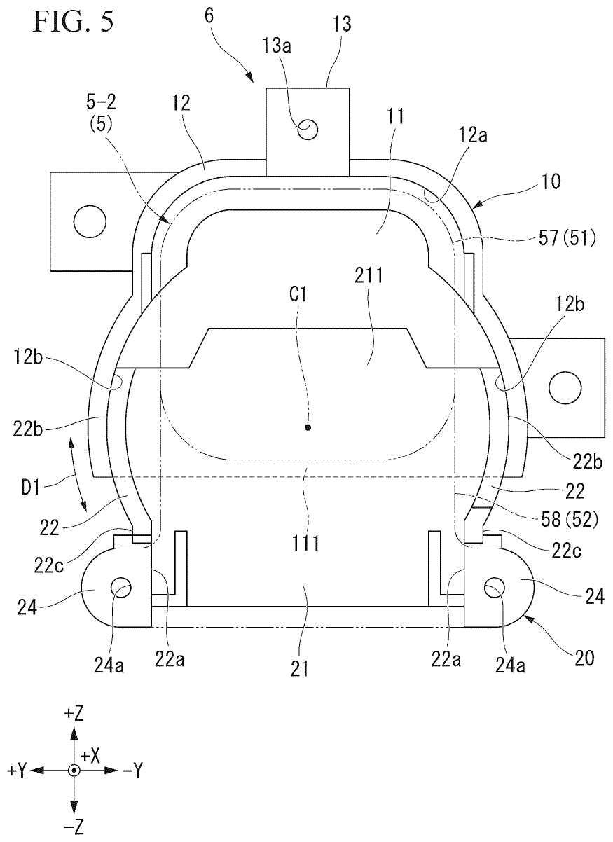

As illustrated in FIGS. 4 and 5, the first shell 10 and the second shell 20 are arranged in order in the −Z direction. A portion of the first shell 10 on a −Z direction side and a portion of the second shell 20 on a +Z direction side overlap each other in the X direction.

### 9. First Shell

The first shell 10 of the present embodiment includes a first cover portion 11, a first side wall 12, and a first fastened portion 13.

The first cover portion 11 is formed in a plate shape with the X direction as a plate thickness direction. The first cover portion 11 mainly covers the first opening 531 (see FIG. 3) of the tubular portion 57 (terminal accommodating portion 51). A portion of the first cover portion 11 on the −Z direction side is a first overlapping portion 111 overlapping a second cover portion 21 of the second shell 20 described below in the X direction. The first overlapping portion 111 is not formed with an opening penetrating in the X direction like a hole.

The first side wall 12 extends in the +X direction (one side in the plate thickness direction of the first cover portion 11) from a part of a peripheral edge of the first cover portion 11. The first side wall 12 is positioned at a portion of the peripheral edge of the first cover portion 11 excluding an edge portion on the-Z direction side, which is adjacent to the second shell 20. In other words, an opening is formed at a portion of the first side wall 12 on the-Z direction side, the first side wall 12 being provided on the peripheral edge of the first cover portion 11.

As illustrated in FIGS. 2 and 4, the first side wall 12 has a first inner side surface 12a and an arc-shaped inner surface (arcuate inner surface) 12b.

The first inner side surface 12a is a surface that faces and covers a part of an outer periphery of the tubular portion 57 in a state in which the shell 6 is attached to the housing 5. In the present embodiment, the first inner side surface 12a is formed at a portion of the first side wall 12 on the +Z direction side. The first inner side surface 12a is formed in a recessed shape recessed toward the +Z direction side when viewed from the X direction.

The arc-shaped inner surface 12b is a surface centered on the axis C1 which is a relative rotation center between the first shell 10 and the second shell 20. In the present embodiment, the arc-shaped inner surface 12b is formed at a portion of the first side wall 12 adjacent to the first inner side surface 12a on the −Z direction side. Specifically, the arc-shaped inner surface 12b is formed to be continuous on the −Z direction side from each of both ends of the first inner side surface 12a having a recessed shape recessed toward the +Z direction side when viewed from the X direction. With such a configuration, the arc-shaped inner surface 12b is positioned at each of both ends of the first cover portion 11 in the Y direction. The two arc-shaped inner surfaces 12b face each other in the Y direction.

The first fastened portion 13 is a portion for fixing the housing 5 to the first shell 10. The first fastened portion 13 is adjacent to the first attaching portion 55 of the housing 5 on the −X direction side in a state in which the housing 5 is attached to the first shell 10. The first fastened portion 13 is formed integrally with the first shell 10. The first fastened portion 13 protrudes in a direction (the +Z direction in the illustrated example) intersecting the X direction from an outer surface of the first side wall 12 of the first shell 10. In the present embodiment, the first fastened portion 13 has a first fastening hole 13a. The first fastening hole 13a is formed to extend in the −X direction from an end portion of the first fastened portion 13 on the +X direction side. The first fastening hole 13a is formed so as not to penetrate through the first fastened portion 13 in the X direction. A female screw to which the shaft portion of the first fastening member 71 can be screwed is formed on an inner peripheral surface of the first fastening hole 13a.

### 10. Second Shell

As illustrated in FIGS. 2 to 5, the second shell 20 of the present embodiment includes a second cover portion 21, a second side wall 22, and a second fastened portion 24. The following positional relationship (direction) will describe the states in FIGS. 4 and 5.

The second cover portion 21 is formed in a plate shape with the X direction as a plate thickness direction. The second cover portion 21 mainly covers the second opening 532 (see FIG. 3) of the guide portion 58 (conductive member accommodating portion 52). A portion of the second cover portion 21 on the +Z direction side is a second overlapping portion 211 overlapping the first cover portion 11 of the first shell 10 in the X direction. In the present embodiment, the second overlapping portion 211 overlaps the first overlapping portion 111 of the first cover portion 11 on the +X direction side (housing 5 side). The second overlapping portion 211 is not formed with an opening penetrating in the X direction like a hole.

The second side wall 22 extends in the +X direction (one side in the plate thickness direction of the second cover portion 21) from a part of a peripheral edge of the second cover portion 21. The second side wall 22 is positioned only at an edge portion on each of both sides of the peripheral edge of the second cover portion 21 in the Y direction, and is not positioned at edge portions on both sides of the peripheral edge of the second cover portion 21 in the Z direction. In other words, openings are formed at portions of the second side wall 22 on the +Z direction side and the-Z direction side, the second side wall 22 being provided on the peripheral edge of the second cover portion 21.

An inner space of the first shell 10 and an inner space of the second shell 20 communicate with each other by forming the opening at the portion of the first side wall 12 on the −Z direction side and forming the opening at the portion of the second side wall 22 on the +Z direction side. In addition, since the opening is formed at the portion of the second side wall 22 on the −Z direction side, the electric wire 2 can be led out to the outside of the guide portion 58 (housing 5) even in a state in which the shell 6 is attached to the housing 5.

As illustrated in FIGS. 2, 4, and 5, each of the two second side walls 22 has a second inner side surface 22a, an arc-shaped outer surface 22b, and a second outer side surface 22c.

The two second inner side surfaces 22a are surfaces facing outer surfaces of the guide portion 58 that face both sides in the Y direction in a state in which the shell 6 is attached to the housing 5. In the present embodiment, each of the second inner side surfaces 22a is formed at an end portion of each of the second side walls 22 on the −Z direction side.

Each of the two arc-shaped outer surfaces 22b is a surface centered on the axis C1. In the present embodiment, each arc-shaped outer surface 22b is formed at an end portion of the second side wall 22 on the +Z direction side. The arc-shaped outer surface 22b of the second side wall 22 is in surface contact with the arc-shaped inner surface 12b of the first side wall 12 in a state in which the second shell 20 is attached to the first shell 10. When the first shell 10 and the second shell 20 are relatively rotated about the axis C1, the arc-shaped inner surface 12b and the arc-shaped outer surface 22b can slide in a circumferential direction D1 about the axis C1.

The second outer side surface 22c is a portion extending in the-Z direction from the arc-shaped outer surface 22b. In other words, the second outer side surface 22c is a portion of the second side wall 22 on the −Z direction side. That is, the second outer side surface 22c is a portion continuous from the arc-shaped outer surface 22b. The second outer side surface 22c extends in the X direction and the Z direction with the Y direction as a thickness direction. The second outer side surface 22c is formed in a shape different from the arc-shaped outer surface 22b so as to form a corner at a connection portion with the arc-shaped outer surface 22b. The second outer side surface 22c of the present embodiment is formed as a flat surface.

The second fastened portion 24 is a portion for fixing the housing 5 to the second shell 20. The second fastened portion 24 is adjacent to the second attaching portion 56 of the housing 5 on the −X direction side in a state in which the housing 5 is attached to the second shell 20. The second fastened portion 24 is formed integrally with the second shell 20. The second fastened portion 24 protrudes in the Y direction from an outer surface of the second outer side surface 22c of the second shell 20. The second fastened portion 24 protrudes in the Y direction from each of the two second outer side surfaces 22c. That is, two second fastened portions 24 are formed.

In the present embodiment, each of the two second fastened portions 24 has a second fastening hole 24a. The second fastening hole 24a is formed to extend in the −X direction from an end portion of the second fastened portion 24 on the +X direction side. The second fastening hole 24a is formed so as not to penetrate through the second fastened portion 24 in the X direction. A female screw to which a shaft portion of the second fastening member 72 can be screwed is formed on an inner peripheral surface of the second fastening hole 24a.

### 11. Fastening Member

As illustrated in FIGS. 1 to 3, the first fastening member 71 and the second fastening member 72 are members that unrotatably fix the housing 5 and the shell 6 to each other. In the present embodiment, one first fastening member 71 and two second fastening members 72 are disposed.

The first fastening member 71 can fasten the first shell 10 and the housing 5. That is, the first fastening member 71 unrotatably fixes the first shell 10 and the housing 5 to each other. The first fastening member 71 is disposed at a position deviated from the second shell 20 when viewed from the X direction (first intersecting direction). The first fastening member 71 includes the shaft portion that can be screwed to the first fastening hole 13a. The shaft portion of the first fastening member 71 can be inserted through the first attachment hole 551.

The second fastening member 72 is disposed at a position away from the first fastening member 71, and can fasten the second shell 20 and the housing 5. That is, the second fastening member 72 unrotatably fixes the second shell 20 and the housing 5 to each other. The second fastening member 72 is disposed at a position deviated from the first shell 10 when viewed from the X direction (first intersecting direction). The second fastening member 72 includes the shaft portion that can be screwed to the second fastening hole 24a. The shaft portion of the second fastening member 72 can be inserted through the second attachment hole 561.

The housing 5 and the shell 6 are fastened as follows by the first fastening member 71 and the second fastening member 72. Note that the order of attachment and fastening described below is an example, and is not limited thereto.

As illustrated in FIG. 4, the second shell 20 is fitted to the first shell 10 from the +X direction. At this time, the first shell 10 and the second shell 20 are attached so as to align the axis C1 which is the relative rotation center. At this time, a member that directly fixes the first shell 10 and the second shell 20 to each other is not disposed. More specifically, when viewed from the X direction (first intersecting direction), another member that connects the first shell 10 and the second shell 20 so as to be rotatable about the axis C1 is not disposed at a position overlapping the first shell 10 and the second shell 20.

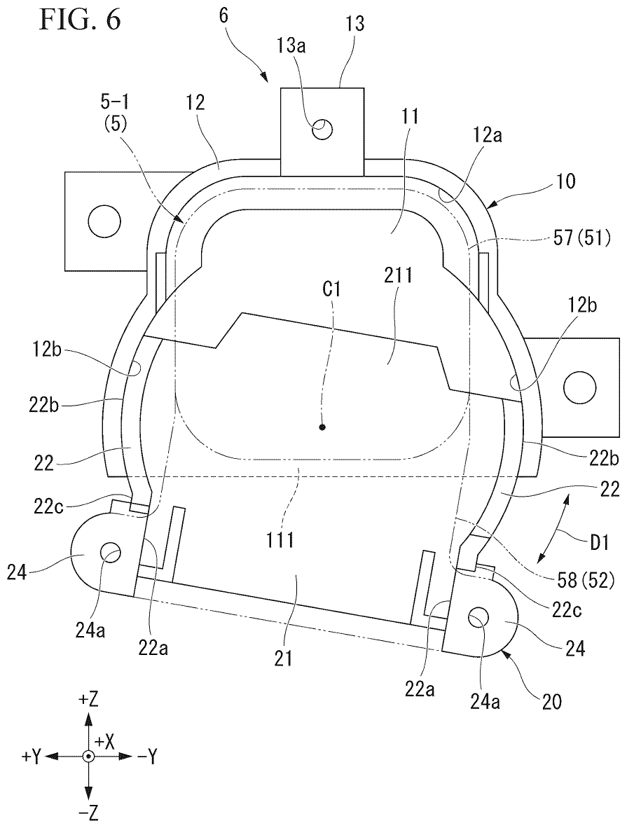

As illustrated in FIGS. 5 and 6, the first shell 10 and the second shell 20 are slidable (rotatable) in the circumferential direction D1 about the axis C1. In addition, the first shell 10 and the second shell 20 are not movable relative to each other in the radial direction with respect to the axis C1 (center). That is, the first shell 10 and the second shell 20 are combined with each other, thereby restricting movement of relative positions in the radial direction with respect to the axis C1 (center). The movement of the first shell 10 and the second shell 20 in the radial direction with respect to the axis C1 is limited in a state in which the housing 5, the first fastening member 71, and the second fastening member 72 are not disposed, and the first shell 10 and the second shell 20 are attachable to and detachable from each other (movable) in the X direction (first intersecting direction).

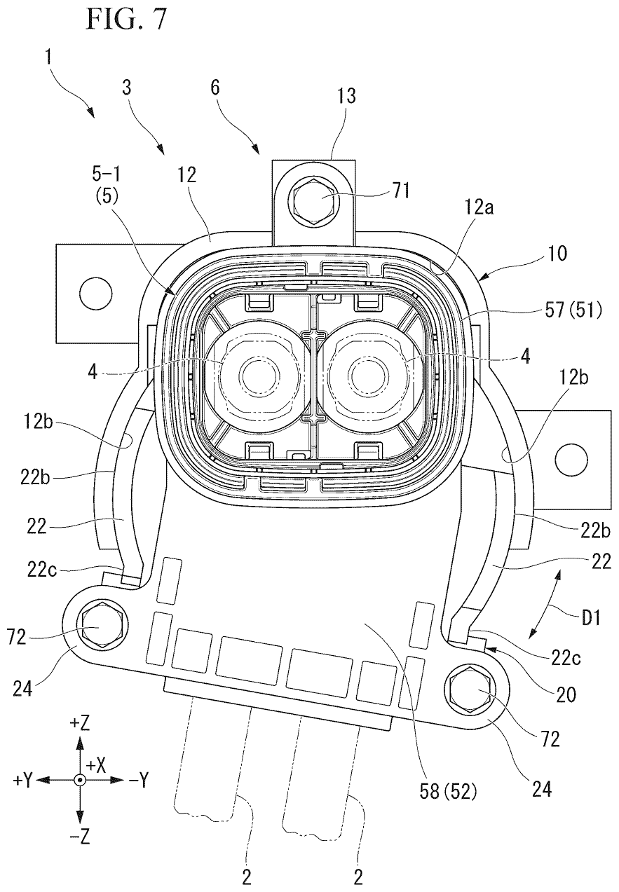

As illustrated in FIG. 6, the second shell 20 is rotated in the circumferential direction D1 about the axis C1 with respect to the first shell 10. In this state, the housing 5 in the present embodiment is fitted and attached to the first shell 10 and the second shell 20 from the +X direction. The first fastening member 71 is disposed so as to sandwich the first attaching portion 55 with the first shell 10. The second fastening member 72 is disposed so as to sandwich the second attaching portion 56 with the second shell 20. FIG. 7 is a view illustrating a state in which the first fastening member 71 and the second fastening member 72 are attached. The first fastening member 71 is disposed at a position deviated from the second shell 20 when viewed from the X direction. The first fastening member 71 unrotatably fixes the first shell 10 and the housing 5 to each other. The second fastening member 72 is disposed at a position deviated from the first shell 10 when viewed from the X direction. The second fastening member 72 unrotatably fixes the second shell 20 and the housing 5 to each other.

When the housing 5 is attached, the first shell 10 and the second shell 20 are not relatively rotatable in the circumferential direction D1 about the axis C1. The first shell 10 and the second shell 20 are fixed via the housing 5 by the first fastening member 71 and the second fastening member 72. That is, the first shell 10 and the second shell 20 are relatively unrotatably fixed to each other in the circumferential direction D1 about the axis C1 by the housing 5, the first fastening member 71, and the second fastening member 72. The relative movement of the first shell 10 and the second shell 20 in the X direction (first intersecting direction) is also restricted by the housing 5, the first fastening member 71, and the second fastening member 72.

### 12. Advantages

According to the present embodiment, the shell 6 covering the opening 53 of the housing 5 includes the first shell 10 that covers at least the first opening 531 corresponding to the terminal accommodating portion 51 in the opening 53 and the second shell 20 that covers at least the second opening 532 corresponding to the conductive member accommodating portion 52 in the opening 53. The first shell 10 and the second shell 20 are rotatable relative to each other about the axis C1 extending in the X direction (first intersecting direction). That is, a direction in which the second shell 20 corresponding to the conductive member accommodating portion 52 extends with respect to the first shell 10 corresponding to the terminal accommodating portion 51 can be changed.

With such a configuration, it is possible to attach the same type of shell 6 to a plurality of types of housings 5 having different extending directions of the conductive member accommodating portion 52 with respect to the terminal accommodating portion 51. For example, the same type of shell 6 can be attached to a housing 5-1 of a first example illustrated in FIGS. 1 to 3, 6, and 7 and a housing 5-2 of a second example illustrated in FIG. 5. This point will be described below.

As illustrated in FIG. 5, in the housing 5-2 of the second example, the guide portion 58 including the conductive member accommodating portion 52 extends in the −Z direction with respect to the tubular portion 57 including the terminal accommodating portion 51. In order to attach the shell 6 to the housing 5-2 of the second example, a relative rotational position between the first shell 10 and the second shell 20 is set such that the second shell 20 extends in the −Z direction with respect to the first shell 10. By setting the relative rotational position between the first shell 10 and the second shell 20 in this manner, the shell 6 can be attached to the housing 5-2 of the second example.

On the other hand, as illustrated in FIG. 6, in the housing 5-1 of the first example, the guide portion 58 including the conductive member accommodating portion 52 extends in an inclined direction inclined toward the +Y direction side as it goes toward the-Z direction with respect to the tubular portion 57 including the terminal accommodating portion 51. In order to attach the shell 6 to the housing 5-1 of the first example, the relative rotational position between the first shell 10 and the second shell 20 is set such that the second shell 20 extends in the above-described “inclined direction” with respect to the first shell 10. By setting the relative rotational position between the first shell 10 and the second shell 20 in this manner, the shell 6 can be attached to the housing 5-1 of the first example.

As described above, since the same type of shell 6 is compatible with various types of housings 5, versatility of the shell 6 can be improved. Therefore, a manufacturing cost of the connector 3 including the housing 5 and the shell 6 can be reduced.

According to the present embodiment, in the shell 6, when viewed from the X direction (first intersecting direction), another member that connects the first shell 10 and the second shell 20 so as to be rotatable about the axis C1 is not disposed at a position overlapping the first shell 10 and the second shell 20. With such a configuration, it is possible to form the shell 6 capable of relatively rotating the first shell 10 and the second shell 20 while reducing the number of components.

According to the present embodiment, the first shell 10 has the arc-shaped inner surface 12b centered on the axis C1, and the second shell 20 has the arc-shaped outer surface 22b centered on the axis C1. The arc-shaped inner surface 12b and the arc-shaped outer surface 22b come into surface contact with each other and slide in the circumferential direction D1 about the axis C1. With such a configuration, the first shell 10 and the second shell 20 can be relatively rotated smoothly and stably. In addition, relative rattling between the first shell 10 and the second shell 20 can be suppressed or prevented, and integrity and strength of the entire shell 6 can be secured.

Further, since the arc-shaped inner surface 12b and the arc-shaped outer surface 22b are in surface contact with each other, it is possible to suppress or prevent generation of a gap between the first shell 10 and the second shell 20 regardless of the relative rotational position between the first shell 10 and the second shell 20. As a result, it is possible to suppress or prevent the terminal accommodating portion 51 and the conductive member accommodating portion 52 of the housing 5 from communicating with the outside due to the gap between the first shell 10 and the second shell 20.

According to the present embodiment, the first fastening member 71 that fastens the first shell 10 and the housing 5, and the second fastening member 72 that is disposed at a position away from the first fastening member 71 and fastens the second shell 20 and the housing 5 are provided. The first shell 10 and the housing 5 are fixed by the first fastening member 71. The second shell 20 and the housing 5 are fixed by the second fastening member 72. With such a configuration, the first shell 10 and the second shell 20 are fixed to each other via the housing 5. Therefore, even if a member that directly connects the first shell 10 and the second shell 20 is not disposed, the first shell 10 and the second shell 20 can be fixed.

### 13. Modified Example

In the above-described embodiment, the first shell 10 has the arc-shaped inner surface 12b centered on the axis C1, and the second shell 20 has the arc-shaped outer surface 22b centered on the axis C1. However, for example, the first shell 10 may have an arc-shaped outer surface, and the second shell 20 may have an arc-shaped inner surface. It is sufficient if the arc-shaped outer surface and the arc-shaped inner surface come into surface contact with each other and slide in the circumferential direction D1 about the axis C1. Even with such a configuration, the same effects as those of the above-described embodiment are obtained.

In the above-described embodiment, the first side wall 12 of the first shell 10 has the first inner side surface 12a. However, the first side wall 12 does not have to have the first inner side surface 12a, for example.

In the above-described embodiment, the first shell 10 includes the first cover portion 11 and the first side wall 12. However, the first shell 10 only needs to include at least the first cover portion 11, and does not have to include, for example, the first side wall 12.

In the above-described embodiment, the second side wall 22 of the second shell 20 has the second inner side surface 22a. However, the second side wall 22 does not have to have the second inner side surface 22a, for example.

In the above-described embodiment, the second shell 20 includes the second cover portion 21 and the second side wall 22. However, the second shell 20 only needs to include at least the second cover portion 21, and does not have to include the second side wall 22, for example.

In the above-described embodiment, the electric wire 2 is directly connected to the terminal 4 of the connector 3. However, the electric wire 2 does not have to be directly connected to the terminal 4 of the connector 3. For example, a bus bar (conductive member) may be connected to the terminal 4 of the connector 3, and the electric wire 2 may be connected to the terminal 4 via the bus bar. In this case, only the bus bar may be accommodated in the conductive member accommodating portion 52 of the housing 5, or the bus bar and a part of the electric wire 2 connected thereto may be accommodated in the conductive member accommodating portion 52 of the housing 5.

One embodiment and modified examples have been described above. However, the embodiment and the modified examples are not limited to the examples described above. For example, the embodiment and the modified examples may be implemented in combination with each other.

### REFERENCE SIGNS LIST

1 Routing unit
2 Electric wire (conductive member)
3 Connector
4 Terminal
5 Housing
6 Shell
10 First shell
11 First cover portion
111 First overlapping portion
12 First side wall
12a First inner side surface
12b Arc-shaped inner surface
13 First fastened portion
13a First fastening hole
20 Second shell
21 Second cover portion
211 Second overlapping portion
22 Second side wall
22a Second inner side surface
22b Arc-shaped outer surface
22c Second outer side surface
24 Second fastened portion
24a Second fastening hole
51 Terminal accommodating portion
52 Conductive member accommodating portion
53 Opening
531 First opening
532 Second opening
54 Insulating wall
55 First attaching portion
551 First attachment hole
56 Second attaching portion
561 Second attachment hole
57 Tubular portion
571 First end
572 Second end
58 Guide portion
71 First fastening member
72 Second fastening member
C1 Axis
D1 Circumferential direction

What is claimed is:

1. A shell attached to a housing including a terminal accommodating portion that accommodates a terminal, a conductive member accommodating portion that is disposed adjacent to the terminal accommodating portion and accommodates a part of a conductive member extending from the terminal, and an opening that opens the terminal accommodating portion and the conductive member accommodating portion to an outside in a first intersecting direction intersecting an arrangement direction of the terminal accommodating portion and the conductive member accommodating portion, the shell comprising:
a first shell that covers at least a first opening corresponding to the terminal accommodating portion in the opening; and
a second shell that covers at least a second opening corresponding to the conductive member accommodating portion in the opening,
wherein
the first shell and the second shell are rotatable relative to each other about an axis extending in the first intersecting direction, and
the first shell and the second shell are disposed so as to be attachable to and detachable from each other in a state of being movable in the first intersecting direction and in a state in which movement in a radial direction with respect to the axis is limited.

2. The shell according to claim 1, wherein
another member that connects the first shell and the second shell so as to be rotatable about the axis is not disposed at a position overlapping the first shell and the second shell when viewed from the first intersecting direction.

3. The shell according to claim 1, wherein
one of the first shell and the second shell has an arc-shaped inner surface centered on the axis,
an other of the first shell and the second shell has an arc-shaped outer surface centered on the axis, and
the arc-shaped inner surface and the arc-shaped outer surface are configured to come into surface contact with each other and slide in a circumferential direction around the axis.

4. A connector comprising:
the shell according to claim 1;
the terminal; and
the housing.

5. The connector according to claim 4, further comprising:
a first fastening member that fastens the first shell and the housing; and
a second fastening member that is disposed at a position away from the first fastening member and fastens the second shell and the housing.
